(19) United States
(12) Patent Application Publication
(10) Pub. No.: US 2006/0032060 A1
(43) Pub. Date: Feb. 16, 2006

(54) Microprismatic shaving surface and shaving implements incorporating said surface

(75) Inventors: Randy Nicolosi, Shelton, CT (US); Glennis Orloff, Woodbridge, CT (US); Brian Balistee, Milford, CT (US); Raymond Guimont, Guilford, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/253,016

(22) Filed: Oct. 18, 2005

Related U.S. Application Data
(63) Continuation of application No. 10/374,448, filed on Feb. 26, 2003.
Application No. 10/374,448 is a continuation-in-part of application No. 09/626,193, filed on Jul. 28, 2000.

(51) Int. Cl. B26B 21/54

(52) U.S. Cl. 30/346.53; 30/50

(57) ABSTRACT

In a microprismatic shaving element for abrasively removing hair, a substrate defines a plurality contiguous raised portions projecting outwardly therefrom. Each of the raised portions defines at least one hair engaging surface and is located on the substrate in an array that defines an abrasive surface. During a shaving operation as the abrasive surface is drawn over the skin of the user, each of the raised portions successively abrades hair extending from extending from said user's skin leaving the ends of the hair frayed after completion of the shaving operation thereby achieving the feel of a smooth shave.

### CROSS REFERENCE TO RELATED APPLICATIONS

This application is a continuation of U.S. patent application Ser. No. 10/374,448, filed Feb. 26, 2003, which is a continuation in part of U.S. patent application Ser. No. 09/626,193, filed Jul. 28, 2000, the disclosure of which are incorporated by reference herein in its entirety.

### FIELD OF THE INVENTION

The present invention is generally directed to shaving implements, and more particularly to shaving surfaces that employ abrasion as a method of hair removal.

### BACKGROUND OF THE INVENTION

Historically, hair removal via shaving has been accomplished using extremely sharp blades generally referred to as razor blades. The blades are usually retained in a housing attached in some manner to a handle. During a shaving operation, the sharpened edge of the razor blade is drawn across a user's skin and cuts the hair as close to the surface of the skin as possible. The closeness of a shave is largely dependant on how close to the skin the blade is able to cut hair protruding therefrom. To achieve a closer shave multiple passes can be made over the same area of skin making successive cuts of the hair, each reducing the amount by which the hair protrudes from the skin. Alternatively, multiple blades can be housed in the razor so that a hair is cut more than once in a single pass. However, the greater the number of passes over a particular area, the greater the potential for becoming cut by the razor blades.

Another drawback associated with the use of conventional razors employing blades occurs in the manufactor of shaving implements employing these blades. Due to the extremely sharp cutting edges, handling difficulties are created. Moreover, the mass production of these blades requires a great deal of equipment, and process control which translates into higher expenses and costs.

Furthermore, where hair is cut using a razor blade, the edge of the hair where it was cut tends to be somewhat sharp so that although a close shave may have been achieved, when one runs a hand across the shaved surface, the feel can be rough. Conversely, if a frayed hair end is achieved, a softer more comfortable feel is accomplished.

Based on the foregoing, it is the general object of the present invention to provide a shaving surface that overcomes the problems and drawbacks of the prior art.

### SUMMARY OF THE INVENTION

The present invention is directed in one aspect to a microprismatic shaving element for abrasively removing hair. The microprismatic shaving element includes a substrate having a plurality of contiguous raised portions projecting outwardly therefrom. Each of the contiguous raised portions defines at least one hair engaging surface. Preferably, the raised portions are arranged on the substrate in an array such that they cooperate to define an abrasive surface. Accordingly, when the shaving implement is used during a shaving operation, the contiguous raised portions defining the abrasive surface successively engage the hair protruding from a user's skin and abrade portions of the hair away, leaving a frayed hair end upon completion of the shaving operation. The frayed hair ends being tactilely smoother, give the feel of a close shave.

The present invention also resides in a disposable shaving cartridge wherein the above-described microprismatic shaving element is incorporated into a housing forming part of the disposable razor cartridge.

In yet another embodiment of the present invention, the microprismatic shaving element is incorporated into a disposable razor having a handle, and a head adapted to carry the microprismatic shaving element.

An advantage of the present invention is that the microprismatic shaving element employs an abrasive hair removal mechanism and as such does not utilize blades having sharpened edges. This reduces the likelihood of a user getting cut during a shaving operation. In addition the handling problems associated with manipulating extremely sharp blades during manufacturing and assembly is greatly alleviated.

### BRIEF DESCRIPTION OF THE DRAWINGS

FIG. 1 is a plan view of a single contiguous raised portion.

FIG. 2 is a perspective view of the contiguous raised portion of FIG. 1.

FIG. 3 is a plan view of a plurality of contiguous raised portions arranged in an array to form a shaving element.

FIG. 4 is a perspective view of an alternate embodiment of the contiguous raised portion of FIG. 1.

FIG. 4a is a perspective view of the contiguous raised portion of FIG. 4.

FIG. 5 is a perspective view of the contiguous raised portion of FIG. 1.

FIG. 5a is a perspective view of the contiguous raised portion of FIG. 5.

FIG. 6 is a perspective view of a disposable razor cartridge including a microprismatic shaving element mounted within a housing.

FIG. 7 is a perspective view of a disposable razor having a cartridge including a microprismatic shaving element mounted within a housing of the cartridge.

### DETAILED DESCRIPTION OF THE PREFERRED EMBODIMENTS

As shown in FIGS. 1-3, a microprismatic shaving element generally designated by the reference number 10 includes a substrate 11 and a plurality of contiguous raised portions 12 projecting outwardly from the substrate 11. The plurality of contiguous raised portions 12 are positioned in side-by-side relationship relative to one another so that they are arranged in an array of rows and columns generally designated by the reference number 14. The peaks and valleys defined by the array 14 of contiguous raised portions 12 define an abrasive surface which, as will be fully explained below, acts to abrade hair protruding from the skin of a user during a shaving operation. The contiguous raised portions 12 shown in the illustrated embodiment are in the form of tetrahedrons. However, as the present invention is not limited in this regard as other microprismatic shapes can be employed without departing from the broader aspects of the present invention.

Preferably, the microprismatic shaving element 10 is formed using methods, such as, but not limited to casting or embossing, from a polymeric material, either of the thermoplastic or thermosetting type. The material should be, but is not required to be flexible. Two materials found to be useful in this regard are polyimide and acrylic, however, the present invention is not limited in this regard as other polymeric materials known to those skilled in the pertinent art to which the present invention pertains can be substituted. In addition, the substrate 11 from which the shaving element 10 is formed can comprise a laminate of two or more layers of the same or different materials bonded one on top of the other. Furthermore, the present invention is not limited to polymeric materials as other materials such as metal strips or metallic foils can also be used.

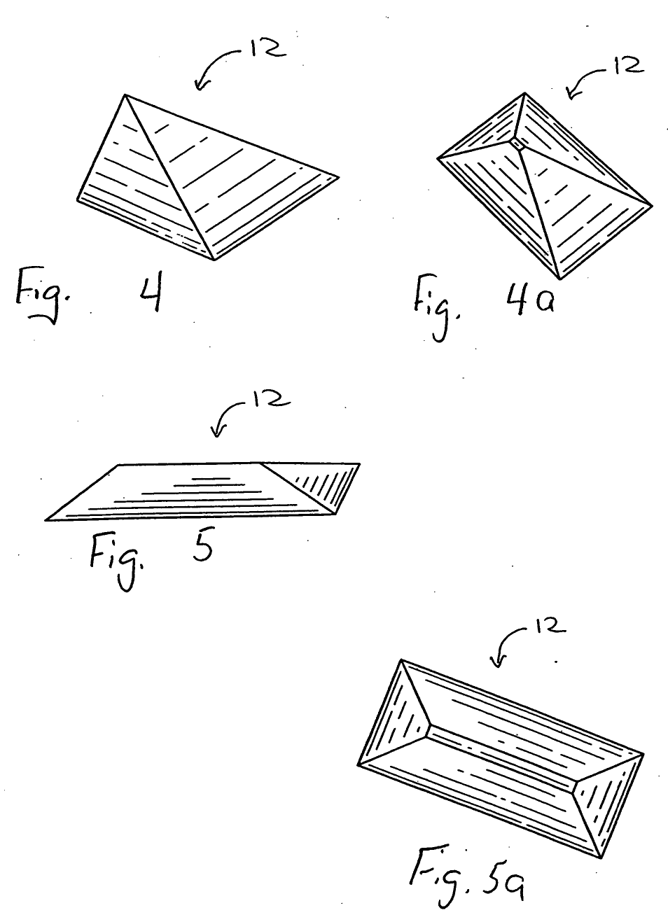

As shown in FIGS. 4-5a, the contiguous raised portions 12 can take many different forms. They can also be tetrahedral, rectangular, octahedral, pentagonal and hexagonal. However, each of the contiguous raised portions defines at least one surface that engages the hair of a user during shaving operation.

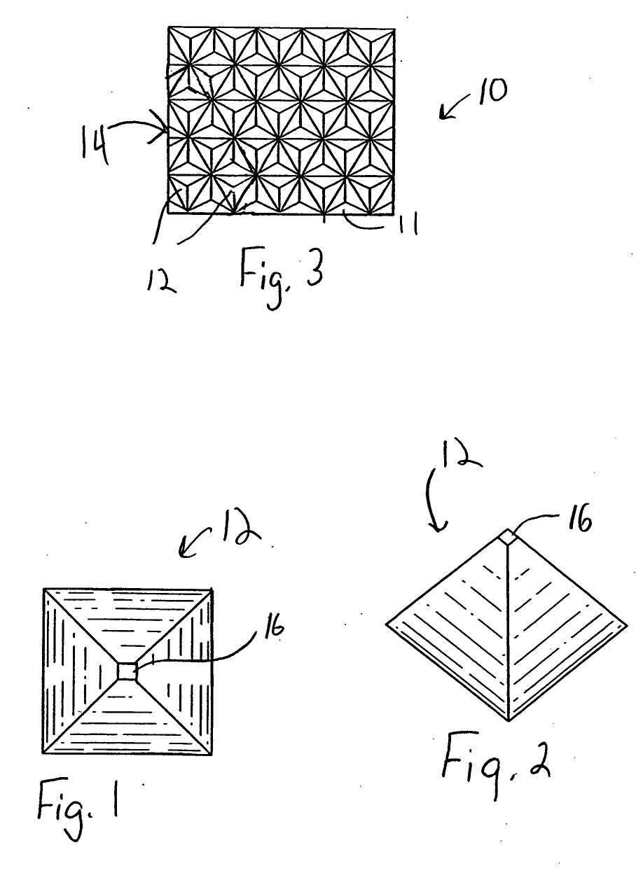

Referring back to FIG. 3, the contiguous raised portions 12 that constitute the abrasive surface 14 are of uniform cross section. However, the invention is not limited in this regard as the cross section of the contiguous raised portions can differ resulting in a staggered surface. In addition, the microprismatic shaving element 10 can be backed with an adhesive layer (not shown) so that it can be mounted onto a shaving implement such as a disposable razor or razor cartridge.

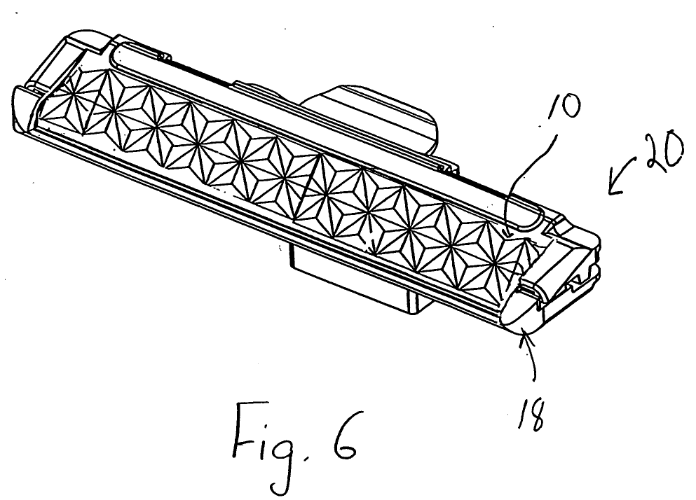

Referring to FIG. 6, the microprismatic shaving element 10 is shown mounted within a housing 18 forming part of a disposable razor cartridge generally designated by the reference number 20. The disposable razor cartridge 20 is adapted to releasably mount onto a razor handle (not shown).

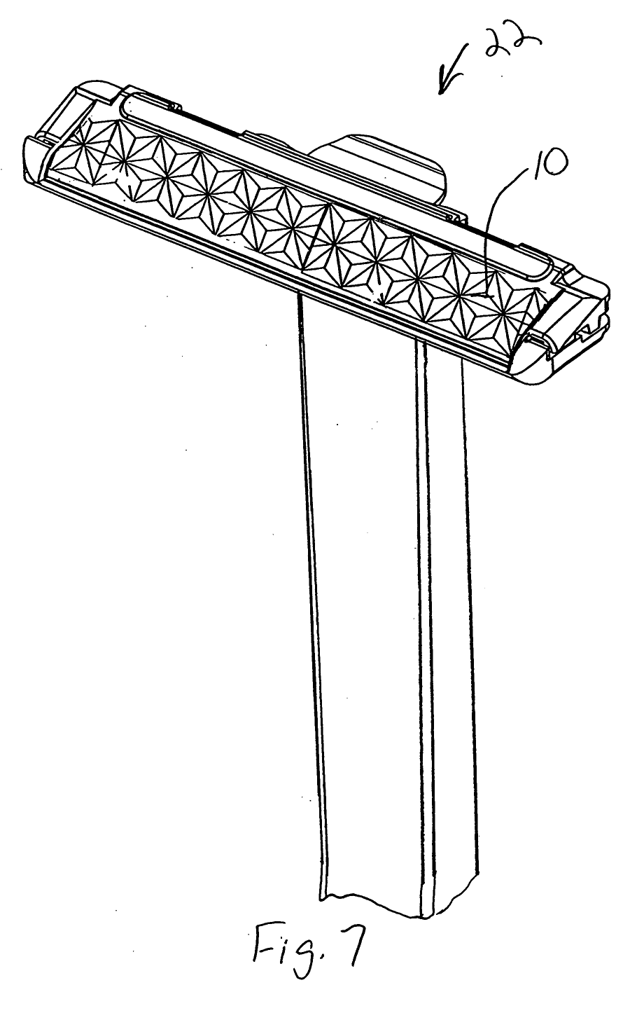

As shown in FIG. 7, the microprismatic shaving element 10 can also form part of a disposable razor generally designated by the reference number 22. The microprismatic shaving element can be mounted to the razor either adhesively or via known mechanical means.

Referring to FIGS. 6 and 7, during a shaving operation, the abrasive surface of the microprismatic shaving element 10 is drawn across the skin of a user. The abrasive surface acts to abrade any hair protruding from the user's skin with which it comes into contact. Upon completion of the shaving operation, the ends of the hair that have come into contact with the abrasive surface are frayed thereby further enhances the feel of a close shave.

While preferred embodiments have been shown and described, various modifications and substitutions may be made without departing from the spirit and scope of the invention. Accordingly, it is to be understood that the present invention has been described by way of example, and not by limitation.

What is claimed is:

1. A microprismatic shaving element for abrasively removing hair, comprising:
a substrate;
a plurality of contiguous raised portions projecting outwardly from said substrate, each defining at least one hair engaging surface;
said raised portions being located on said substrate in an array, that defines an abrasive surface; and wherein
during a shaving operation, as said abrasive surface is drawn over the skin of a user, each of said raised portions successively abrades hair extending from said user's skin, leaving the ends of said hair frayed after completion of said shaving operation, thereby achieving the feel of a smooth shave.

2. A microprismatic shaving element as defined by claim 1 wherein said microprismatic shaving element is formed from a polymeric material.

3. A microprismatic shaving element as defined by claim 2 wherein said polymeric material is a thermoplastic.

4. A microprismatic shaving element as defined by claim 2 wherein said polymeric material is a thermoset material.

5. A microprismatic shaving element as defined by claim 1 wherein said shaving element is formed from a laminate.

6. A microprismatic shaving element as defined by claim 1 wherein said shaving element is flexible.

7. A microprismatic shaving element as defined by claim 1 wherein each of said contiguous raised portions is triangular.

8. A microprismatic shaving element as defined by claim 1 wherein each of said contiguous raised portions is hexagonal.

9. A microprismatic shaving element as defined by claim 1 wherein each of said contiguous raised portions is rectangular.

10. A disposable shaving cartridge comprising:
a housing having a portion adapted to releasably mate with a razor handle;
an abrasive strip coupled to said housing and defining an outwardly facing surface having a plurality of contiguous raised portions projecting outwardly therefrom;
each of said contiguous raised portions defining at least one hair engaging surface said contiguous raised portions collectively defining an abrasive surface; and whereby
as said shaving cartridge is drawn across the skin of a user during a shaving operation, said abrasive surface contacts any hair protruding from the user's skin so that each of said microprismatic elements abrades said hair removing a portion thereof and leaving a frayed end thereby yielding the feel of a close shave.

11. A disposable shaving cartridge as defined by claim 10, wherein said abrasive strip is flexible.

12. A disposable shaving cartridge as defined by claim 10, wherein said abrasive strip is polymeric.

13. A shaving implement comprising:
a handle;
a shaving head coupled to said handle and including;
an abrasive strip coupled to said shaving head and defining an outwardly facing surface having a plurality of contiguous raised portions projecting therefrom;
each of said contiguous raised portions defining at least one hair engaging surface, said contiguous raised portions collectively defining an abrasive surface; and whereby
as said abrasive strip is drawn across the skin of a user during a shaving operation, said abrasive surface contacts any hair protruding from the user's skin so that each of said microprismatic elements abrades said hair removing a portion thereof and leaving a frayed end thereby yielding the feel of a close shave.

14. A shaving implement as defined by claim 13 wherein said abrasive strip is polymeric.

15. A shaving implement as defined by claim 13 wherein said abrasive strip is flexible.
